(19) United States
(12) Patent Application Publication
(10) Pub. No.: US 2019/0319476 A1
(43) Pub. Date: Oct. 17, 2019

(54) MOBILE PHONE CLIP WITH INDICATOR LAMPS FOR WIRELESS CHARGING

(71) Applicant: Shenzhen Xgear Technology Co., Ltd., Shenzhen (CN)

(72) Inventor: Yan Hou, Changsha (CN)

(21) Appl. No.: 16/382,188

(22) Filed: Apr. 11, 2019

(30) Foreign Application Priority Data
Apr. 17, 2018 (CN) 201820544035.5

(51) Int. Cl. H02J 7/02; H02J 7/00; F16B 2/22

(52) U.S. Cl. CPC H02J 7/027; F16B 2/22; H02J 7/0042; H02J 7/025

(57) ABSTRACT

The present invention relates to a mobile phone clip with indicator lamps for wireless charging, comprising a clip body and clamping blocks, at least one end of the clamping block is connected with the clip body in a stretchable manner; charging indicator lamps are also arranged on the stretchable clamping blocks; a wireless charging module is arranged in the clip body; the charging indicator lamps are connected with PCBA of the wireless charging module through a soft cable; and the freely stretchable length of the soft cable is larger than the stretchable length when the clamping blocks are stretched to the largest degree. In the present invention, the charging indicator lamps are arranged on the clamping blocks of the mobile phone clip, and the charging indicator lamps indicate a charging state. In this way, whether the mobile phone is charging can be rapidly judged, to prompt a user.

### CROSS REFERENCE TO RELATED APPLICATIONS

The present application claims the benefit of Chinese Patent Application No. 201820544035.5 filed on Apr. 17, 2018, the contents of which are incorporated herein by reference in its entirety.

### TECHNICAL FIELD

The present invention relates to an auxiliary product of a mobile phone, and particularly to a mobile phone clip with indicator lamps for wireless charging.

### BACKGROUND

Smart phones have more and more functions. People become accustomed to handling many affairs through mobile phones in modern life. The automobile is also one of the articles for daily use which are more and more popular in the modern society. Therefore, the mobile phones are increasingly used on the automobile. However, a safety problem is involved when the mobile phones are used on the automobile. A traffic accident may be often caused in case of answering or making calls during driving. To reduce the danger to a driver caused by answering or making calls during driving, a vehicle-mounted mobile phone clip is invented. The clip is used to fix the mobile phone to a center console or an air outlet of an air conditioner in the automobile. Because the endurance of a battery of the smart phone is generally poor, in order to timely charge, the mobile phone will be charged through a charging line from a charge pal or a cigarette lighter. Later, in order to provide a wireless charging function for the smart phone, people began to study how to use wireless charging on the mobile phone clip. However, wireless charging requires a wireless charging coil of the mobile phone and a wireless charging coil on the mobile phone clip to be coincident or basically coincident. Thus, it is not clear whether charging is conducted or not. Sometimes, unsuccessful charging may be considered as charging by mistake, which is easy to cause a delay.

### SUMMARY

The purpose of the present invention is to overcome the above disadvantages and defects in the prior art, and provide a novel mobile phone clip with indicator lamps for wireless charging. The mobile phone clip with indicator lamps for wireless charging in the present invention is convenient in operation, practical and good in stability. The present invention is mainly used on a vehicle-mounted mobile phone bracket, and can also be used on other mobile phone brackets.

The purpose of the present invention is realized by the following technical solution:

A mobile phone clip with indicator lamps for wireless charging comprises a clip body and clamping blocks, wherein the clamping blocks are connected to both ends of the clip body; at least one end of the clamping block is connected with the clip body in a stretchable manner; charging indicator lamps are also arranged on the stretchable clamping blocks; a wireless charging module is arranged in the clip body; the charging indicator lamps are connected with PCBA of the wireless charging module through a soft cable; the soft cable presents U shape or J shape in the clip body; and the freely stretchable length of the soft cable is larger than the stretchable length when the clamping blocks are stretched to the largest degree. In the present invention, the charging indicator lamps are arranged on the clamping blocks of the mobile phone clip, and the charging indicator lamps indicate a charging state. In this way, whether the mobile phone is charging can be rapidly judged, to prompt a user. If charging is not realized, the indicator lamps do not light or present a certain set color. If charging is in progress or is completed, another set color is indicated, so that the user knows whether the mobile phone is charging and whether charging is normal. The soft cable is connected with a circuit board of the charging module in order to ensure that the indicator lamps still can be connected with the circuit board when the clamping blocks are stretched. At the same time, the freely stretchable length of the soft cable is set to be larger than the stretchable length when the clamping blocks are stretched to the largest degree. In this way, when the blocks are stretched furthest, the soft cable is not broken and is also in a communication state. Moreover, a transverse wiring duct can be arranged in the clip body and used to put the soft cable. In the process of stretching and contracting the clamping blocks, the soft cable slides in the wiring duct, so as to prevent cluttered branches of the soft cable from moving and touching other elements of the circuit board, which may break the soft cable.

Another preferred solution of the present invention is: the surface of the clip body in the region of the wireless charging coil is oval. The surface of the clip body in the region of the wireless charging coil is set to be oval, which is convenient for placing the wireless charging coil. At the same time, the user can see the charging region at a glance, which is convenient for the user to correspond a charging coil of the mobile phone to the wireless charging coil on the clip body, thereby increasing the success rate of charging and reducing misoperation.

Another preferred solution of the present invention is: the clamping blocks on both ends of the clip body are stretchable. The clamping blocks on both ends are stretchable, so that the charging region of the clip body is easier to correspond to the charging coil of the mobile phone.

Another preferred solution of the present invention is: the charging indicator lamps are arranged on the clamping blocks on both ends. Two indicator lamps can better indicate the charging state. Even if one indicator lamp fails, the other indicator lamp still indicates the charging state, so as to avoid misoperation.

Another preferred solution of the present invention is: the clamping blocks are arc-shaped blocks which are gradually contracted upwards. In the present invention, the clamping blocks are configured to be arc-shaped blocks which are gradually contracted upwards. The clamping blocks of the existing mobile phone bracket are vertically upward for the convenience of production. However, such vertically upward clamping blocks can only provide a left-right acting force to the mobile phone, which is unstable to clamp. Especially after a clamping force is reduced, when the mobile phone is clamped by the vertical clamping blocks, mobile phone is easy to drop. However, after the clamping blocks are configured to be arc-shaped blocks which are gradually contracted upwards, the arc-shaped blocks provide an obliquely upward force to the mobile phone from below and an obliquely downward force to the mobile phone from above in addition to the left-right clamping force to the mobile phone, thereby greatly increasing the acting force to the mobile phone, enhancing the stability of the mobile phone and realizing the clamping of the mobile phone under a small force of a spring or a rubber ring.

Another preferred solution of the present invention is: soft cushions are also arranged on the inner surfaces of the clamping blocks. The soft cushions provide a buffering force for the mobile phone, so as to avoid wearing a coating on the mobile phone body due to hard contact between the mobile phone and the clamping blocks. At the same time, the soft cushions increase the frictional force between the mobile phone and the clamping blocks, so that the clamping is more stable.

### BRIEF DESCRIPTION OF DRAWINGS

FIG. 1 is a structural schematic diagram of a mobile phone clip with indicator lamps for wireless charging in Embodiment 1 of the present invention.

FIG. 2 is a structural schematic diagram when a mobile phone clip is equipped with an air outlet base of an automobile in Embodiment 1 of the present invention.

FIG. 3 is a structural schematic diagram of a shape when a soft cable of a mobile phone clip is inside a clip body in Embodiment 1 of the present invention.

### DETAILED DESCRIPTION

Some preferred embodiments of the present invention are provided below in order to further understand the present invention.

### Embodiment 1

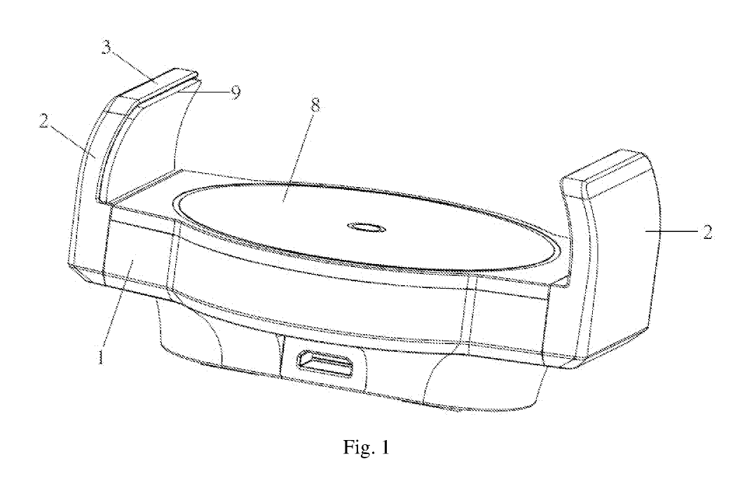

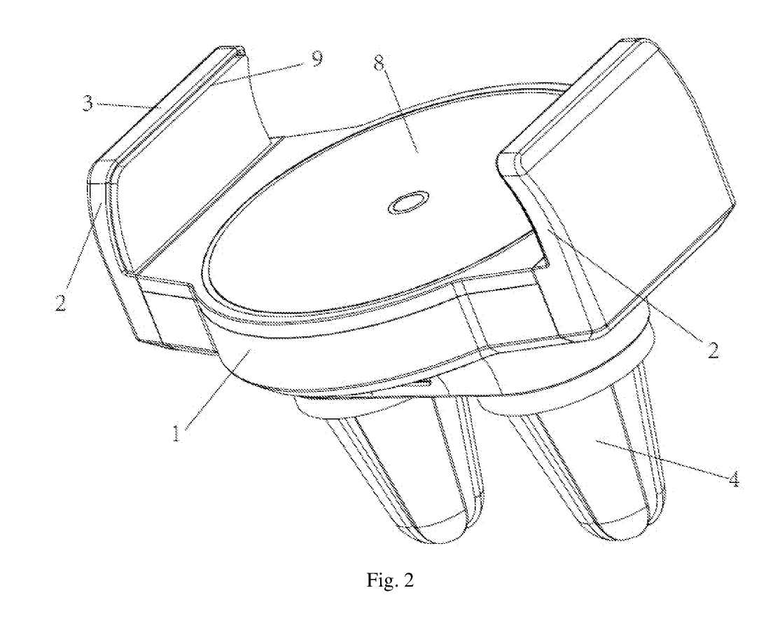

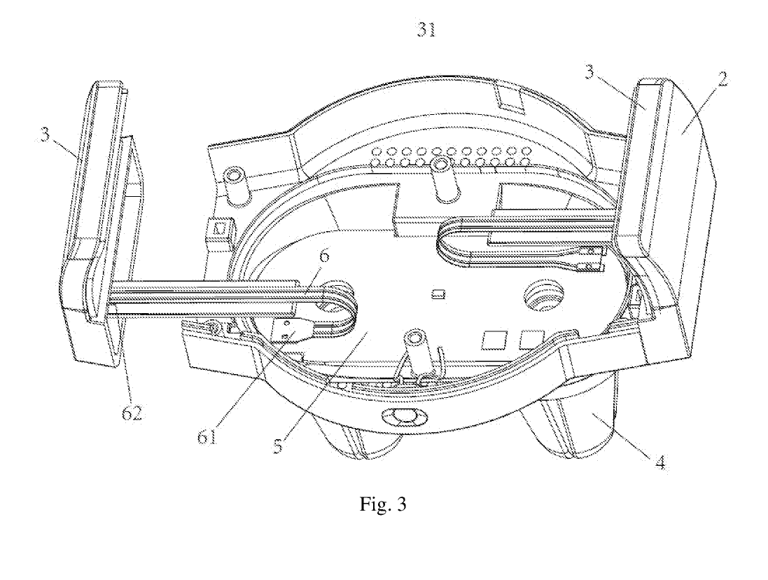

The present embodiment is one of preferred implementation solutions of the present invention. FIG. 1 is a structural schematic diagram of a mobile phone clip with indicator lamps for wireless charging in Embodiment 1 of the present invention. FIG. 2 is a structural schematic diagram when a mobile phone clip is equipped with an air outlet base of an automobile in Embodiment 1 of the present invention. FIG. 3 is a structural schematic diagram of a shape when a soft cable of a mobile phone clip is inside a clip body in Embodiment 1 of the present invention.

As shown in FIGS. 1, 2 and 3, a mobile phone clip with indicator lamps for wireless charging comprises a clip body 1 and clamping blocks 2, wherein the clamping blocks are connected to both ends of the clip body; at least one end of the clamping block is connected with the clip body in a stretchable manner; charging indicator lamps 3 are also arranged on the stretchable clamping blocks; a wireless charging module is arranged in the clip body; the charging indicator lamps are connected with PCBA 5 of the wireless charging module through a soft cable 6; the soft cable presents U shape or J shape in the clip body; and the freely stretchable length of the soft cable is larger than the stretchable length when the clamping blocks are stretched to the largest degree. The surface of the clip body in the region 8 of the wireless charging module is oval. The clamping blocks are arc-shaped blocks which are gradually contracted upwards. Soft cushions 9 are also arranged on the inner surfaces of the clamping blocks. 5 indicates PCBA of the wireless charging module. The soft cable 6 is electrically connected to the PCBA. 61 indicates a welded joint. 62 indicates another end of the soft cable, and 62 is electrically connected to the indicator lamp 3. It can be known from the figures that, the freely stretchable length of the soft cable is larger than the stretchable length when the clamping blocks are stretched to the largest degree. Namely, the length of the soft cable 6 from the welded joint 61 with PCBA to a cable end 62 connected with the indicator lamp is greater than the length when the clamping blocks are completely stretched (the clamping block on the left end in FIG. 3 is in a completely stretched state, and the clamping block on the right end is in a completely contracted state). In this way, when the clamping blocks are stretched to the largest length, the soft cable may not be broken, thereby ensuring normal operation of the indicator lamps. The present invention especially disposes the welded joint reversely. Even if the soft cable presents U shape or J shape, the soft cable can be smoothly stretched out or retracted in during stretching or contraction of the clamping blocks.

Without such arrangement, if the welded joint is arranged forwardly in an ordinary mode, the entire soft cable will present Z shape, and is very easy to collide with other elements during stretching or contraction and also very easy to drop for welding with PCBA during use.

During use, a base 4 which can be clamped on an air outlet blade of the air conditioner of the automobile can be added, and can be used on the automobile. A base or rod of another form can also be connected. The mobile phone clip with indicator lamps for wireless charging in the present invention is fixed to a table for use.

The above embodiments are preferred implementation modes of the present invention. However, the implementation modes of the present invention are not limited by the above embodiments. Any other change, modification, replacement, combination and simplification made without departing from the spiritual essence and principle of the present invention shall be equivalent substitution mode, and shall be contained within the protection scope of the present invention.

What is claimed is:

1. A mobile phone clip with indicator lamps for wireless charging, comprising a clip body and clamping blocks, wherein the clamping blocks are connected to both ends of the clip body; at least one end of the clamping block is connected with the clip body in a stretchable manner; charging indicator lamps are also arranged on the stretchable clamping blocks; a wireless charging module is arranged in the clip body; the charging indicator lamps are connected with PCBA of the wireless charging module through a soft cable; the soft cable presents U shape or J shape in the clip body; and the freely stretchable length of the soft cable is larger than the stretchable length when the clamping blocks are stretched to the largest degree.

2. The mobile phone clip with indicator lamps for wireless charging according to claim 1, wherein the surface of the clip body in the region of the wireless charging module is oval.

3. The mobile phone clip with indicator lamps for wireless charging according to claim 1, wherein the clamping blocks on both ends of the clip body are stretchable.

4. The mobile phone clip with indicator lamps for wireless charging according to claim 3, wherein the charging indicator lamps are arranged on the clamping blocks on both ends.

5. The mobile phone clip with indicator lamps for wireless charging according to claim 1, wherein the clamping blocks are arc-shaped blocks which are gradually contracted upwards.

6. The mobile phone clip with indicator lamps for wireless charging according to claim 1, wherein soft cushions are also arranged on the inner surfaces of the clamping blocks.
